(19) United States
(12) Patent Application Publication
(10) Pub. No.: US 2001/0049423 A1
(43) Pub. Date: Dec. 6, 2001

(54) METHOD FOR REDUCING CONSOLIDATION FORCE TO IMPROVE SOLIDS FLOWABILITY FOR GRANULAR MATERIAL

(76) Inventors: DUAN-FAN WANG, SOMERVILLE, NJ (US); RONALD STEVEN EISINGER, CHARLESTON, WV (US)

Correspondence Address: WHYTE HIRSCHBOECK DUDEK S.C., 111 E. WISCONSIN AVE, SUITE 2100, MILWAUKEE, WI, 53202, US

(21) Appl. No.: 09/313,601

(22) Filed: May 18, 1999

(51) Int. Cl. C08F 2/34

(52) U.S. Cl. 526/61; 526/59; 526/70; 526/74

(57) ABSTRACT

There is provided a bulk handling method for maintaining granular material in a free-flowing state in a vessel during storing, transporting, or while in an idle mode in a fluidized-bed reactor or purger.

### FIELD OF THE INVENTION

The present invention relates to a method of bulk handling materials that agglomerate or pack together on standing and/or over time. More particularly, the present invention relates to a method for bulk handling of granular materials including polymers, such as sticky polymers (especially ethylene-propylene elastomers and ethylene-propylene-diene elastomers) that have a tendency to agglomerate or compact with standing or upon storage over time.

### BACKGROUND OF THE INVENTION

Only recently have sticky polymers such as EPRs (ethylene-propylene rubbers) and/or EPDMs (ethylene-propylene-diene rubbers) been produced commercially in a gas fluidized polymerization process in the presence of an inert particulate material or fluidization aid (carbon black, silica, talc, clay, etc.). The use of inert particulate material maintains the bed of forming polymer during polymerization in a fluidized state and renders the polymeric particle so formed free-flowing.

However, it has been discovered that, even though the polymer particles produced by this process are rendered non-sticky by the inert particulate material, with time or upon standing during storage or transporting, the elastomeric material tends to compact or consolidate. When this phenomenon occurs, it is difficult to discharge or restore free-flowing capability to the elastomeric particles.

There are a number of ways in the solids handling industry to improve solids flowability and discharge after consolidation has occurred in storage or transportation. Typically, air blasting, vibration techniques, or aeration are employed upon the packed material to counter-act consolidation forces and generate forces to disperse loose agglomerates and break bridging that has taken place. Techniques such as air blasting, vibration, and aeration are used to resolve solids handling problems after they have occurred. These techniques fail when the strength of the packed materials is stronger than the force generated by these techniques.

The strength of packed materials, especially polymers such as sticky polymers, is a function of consolidation force and storage time. This strength increases with the consolidation forces, and it increases as an exponential function of the storage time before reaching its maximum strength. Often materials such as sticky polymers can become so compacted that conventional methods of restoring flow (i.e., air blasting, vibration, and aeration) cannot make them flow again.

Accordingly, there is a need for a preventive method for solving handling problems associated with polymers, including sticky polymers, especially those produced in gas phase processes, that can improve or maintain solids flowability after long term storage and/or transportation.

### SUMMARY OF THE INVENTION

The invention provides a bulk handling method for maintaining granular material in a free-flowing state comprising

(i) loading the granular material into a vessel equipped with a gas distributor at or near the bottom of said vessel and a discharge means in the bottom of said vessel;

(ii) injecting a gas that is inert to said granular material upwardly through the gas distributor and through the granular material at a gas velocity that is equal to or slightly below the minimum fluidization velocity of said granular material in the vessel.

### DETAILED DESCRIPTION OF THE INVENTION

The method of the present invention is a preventive one that can be applied to storage (e.g., in a bin or silo) and transportation (e.g., in a hopper car) of granular material, especially to elastomers such as sticky polymers. The inventive method is, likewise, applicable to idle mode operation of a gas fluidized bed reactor (including a stirred gas fluidized reactor) or a gas purger, such as those employed in gas phase fluidized processes, where agglomeration, caking, or bridging of particles is a concern, such as, for example, when either or both of these vessels are stopped and restarted.

In the method of the invention, the vessel or container is equipped with a gas distributor or gas distributor plate located at or near the bottom of the vessel as well as a means for discharging the granular material. The vessel and especially the gas distributor are designed using known technology so as to provide uniform gas injection into the container. A conical-hopper distributor is preferred when the vessel is a reactor, purger, bin, or silo. A plane-flow hopper distribution is preferred for a hopper car. While gas injection can be conducted intermittently, it is preferred that the gas injection take place continuously.

When material has reached the desired fill level in the vessel, gas is injected upward through the gas distributor and into and through, preferably uniformly through, the granular material. The gas employed can be any gas that is inert to the material. Such gases can include air, nitrogen, argon, cycle gas, and an alkane having 1 to 20 carbon atoms (e.g., ethane, propane, butane, isopentane, hexane, etc.) that is a gas at ambient temperatures and pressures. Air and nitrogen are preferred, especially in storage applications for bins, silos, and hopper cars. Cycle gas is preferred for use in reactors and purgers. Of course, a mixture of any of the above gases can be employed. The gas (e.g., air) can be vented to the atmosphere such as during transport (hopper cars) and in storage (bins and silos), but preferably the gas is recycled when in idle mode in the reactor and purging vessels.

Gas temperatures, in general, depend upon the type of polymer and/or its stickiness which in turn is dependent upon the type and amount of monomer(s) employed, and particle size and/or density. Gas temperatures which promote agglomeration of the polymer particles should be avoided. The temperature of the gas can range, in general from ambient to 90 degrees C. In a preferred embodiment the gas is heated to a temperature ranging from about 50° C. to 90° C.

Under consolidation, the strength of packed materials, such as polymers produced using olefins and/or diolefins, and especially sticky polymers, increases as an exponential function of storage or standing time before reaching its maximum strength. The invention is employed such that the flowability of the granular, especially polymeric or elastomeric, material is maintained because the consolidation force is mitigated by the injection of a gas, particularly by the drag force exerted by the gas. The consolidation force is defined as the force (e.g., gravitational pull) exerted upon storage or standing that compacts or agglomerates the granular material. Drag force is defined as the friction force exerted on a solid body by fluid (e.g., a gas) that flows around the solid body. The drag force of the injected gas minimizes or reduces the consolidation force by balancing the weight of product material inside the vessel. The higher the inert gas velocity employed, the larger the drag force created.

It is preferable to inject constantly into the vessel an amount of gas at a superficial velocity close to or slightly exceeding the minimum fluidization velocity (i.e., ±2 to 10% of the total minimum fluidization velocity) of the material lodged in the vessel while it is being stored, transported, or when the vessel is in an idling mode. The benefits of introducing gas flow at the minimum fluidization velocity rather than at a greater fluidizing velocity include conservation of gas or less energy requirement for recycling it, negligible entrainment of fines from the vessel, and/or negligible back-mixing of particles. Minimum fluidization velocity is determined by using published empirical equations such as those disclosed in FLUIDIZATION, 2^{nd} edition, by J. F. Davidson, R. Clift, and D. Harrison, Academic Press (1985) or FLUIDIZING ENGINEERING, 2^{nd} edition, by Daizo Kunii and Octave Levenspiel, Butterworth-Heinemann (1991), for example.

For fine particles, the Wen and Yu equation C. Y. Wen and Y. H. Yu, AIChE J., 12, p.610(1966) is:

Rep,mf=[(33.7)²+0.0408Ar]^{½}−33.7

where:

$$Ar = \frac{{d}_{p}^{3} {ρ}_{g} ( {ρ}_{s} - {ρ}_{g} ) g}{{μ}^{2}}$$

and

Ar=Archimedes number

dp=particle diameter

ρg=gas density

ρs=solids density

g=acceleration

μ=gas viscosity

Preferably, the velocity of the gas is equal to the minimum fluidization velocity of the granular material contained in the vessel. For granular gas phase elastomeric material in general, the gas superficial velocity ranges from about 0.05 to 0.35 ft/s, preferably about 0.15 to 0.25 ft/s. And, preferably upon discharge from the vessel and/or shipping container, the gas velocity is lowered to that which is less than 10% of the minimum fluidization velocity. For polymers with the average particle size of 0.25 inches and a particle density of about 0.7 to 0.8 g/cm³, the gas velocity used during discharge will be equal to or less than 0.025 ft/s. In this manner, much smaller amounts of aeration gas is used to assist material flowing during discharge.

Polymers employable in the present invention are preferably produced in a variety of gas phase fluidized bed processes. These can include so-called “conventional” gas phase processes, “condensed-mode,” and, most recent, “liquid-mode” processes. In these processes, it may be desirable to include a scavenger in the reactor to remove adventitious poisons such as water or oxygen before they can lower catalyst activity. The catalysts employed in these processes utilize transition metals (including metallocenes, typically containing titanium, hafnium, or zirconium) such as vanadium, titanium, nickel, cobalt and rare earth or the so-called lanthanide metals (e.g., Nd). These catalysts are utilized in supported, unsupported, liquid (including neat, solution, or slurry) forms or spray dried (with/without filler).

Conventional fluidized processes are disclosed, for example, in U.S. Pat. Nos. 3,922,322; 4,035,560; 4,994,534, and 5,317,036.

Condensed mode polymerizations, including induced condensed mode, are taught, for example, in U.S. Pat. Nos. 4,543,399; 4,588,790; 4,994,534; 5,317,036; 5,352,749; and 5,462,999.

Liquid mode or liquid monomer polymerization mode is described in U.S. Pat. No. 5,453,471; and WO 96/04323 (PCT/US95/09826). For a polymerization utilizing a diene (diolefin), it is preferable to use liquid mode and to employ an inert particulate material, a so-called fluidization aid or flow aid.

The polymers can also be produced in processes such as those described in U.S. Pat. No. 5,086,132.

Inert particulate materials that may be contained in the polyomers, particularly in elastomers and/or stickypolymers and used in the polymerization processes are described, for example, in U.S. Pat. No. 4,994,534 and include carbon black (including modified carbon blacks as disclosed in WO 98/34960), silica, clay, talc, activated carbon (as disclosed in EP 0 727,447), and mixtures thereof. Organic polymeric materials (e.g., polymers and copolymers of an alpha olefin and polystyrene, in granular or powder form) can also be employed as fluidization aids. Of these, carbon black, silica, and mixtures of them are preferred. When employed as fluidization aids, these inert particulate materials are used in amounts ranging from about 0.3 to about 80% by weight, preferably about 5 to 60%, most preferably 10 to 45%, based on the weight of the polymer produced. Organic polymeric materials are employed in amounts ranging from 0.3 to 50%, preferably 0.3 to 10% by weight based upon the weight of the final polymer produced. The use of these inert particulate materials generally imparts a core-shell structure to the elastomer particle as disclosed in U.S. Pat. No. 5,304,588.

Any polymer can be employed in the present invention. Such polymers (homopolymers and copolymers) can be produced from monomers such as, for example, olefins (typically alpha olefins having 2 to 12 carbon atoms) and/or diolefins, both conjugated and non-conjugated, such as butadiene, isoprene, ENB, etc. Particularly preferred are the so-called sticky polymers, preferably containing inert particulate material, produced by these processes and they can include ethylene-propylene rubbers (EPRs), ethylene-propylene-diene rubbers (EPDMs), polybutadiene rubbers, ethylene-butene and ethylene-butene-diene rubbers, high ethylene content propylene-ethylene block copolymers, poly(1-butene) (when produced under certain reaction conditions), very low density (low modulus) polyethylenes, i.e., ethylene-butene rubbers or hexene containing terpolymers. The method is particularly applicable to ethylene-propylene rubber, ethylene-propylene-diene rubbers in which the diene is selected from the group consisting of ethylidene norbornene (e.g., ENB), hexadiene, and a methyloctadiene (e.g., MOD).

All references are incorporated herein by reference.

Whereas the scope of the invention is set forth in the appended claims, the following examples illustrate certain aspects of the present invention. The examples are set forth for illustration and are not necessarily to be construed as limitations on the invention, except as set forth in the claims. Throughout the specifications all parts and percentages are by weight unless otherwise stated.

### EXAMPLES

### Example 1

### Comparative

This example demonstrates the tendency of EPR polymers to agglomerate. Five pounds of ethylene-propylene-ethylidene norbornene rubber made in accordance with a gas phase process as described in U.S. Pat. No. 4,994,534 were loaded into a Plexiglas® column (6.5 inches in diameter and 10 inches in height). Hot gas (65° C.) was injected at a rate of 1.0 ft/s into the bottom of the column through a conical-hopper distributor to heat and fluidize the elastomer. When the elastomeric particles were heated to 65° C., the gas was turned off and the elastomeric material de-fluidized. The elastomer was stored inside the column for 6 hours at 65° C. At the end of this period, the elastomer had agglomerated into a solid mass and failed to be dislodged and discharged from the column.

### Example 2

This example demonstrates the invention. The procedure in Example 1 was repeated, except that once the elastomer was heated to 65° C., the gas flow rate was reduced to 0.18 ft/s such that the elastomer particles de-fluidized. The elastomeric material was maintained in inside the column for 6 hours at 65° C. and at the 0.18 ft/s flow rate (that was close to, but below the minimum fluidization velocity of 0.25 ft/s). At the conclusion of the 6 hour period, gas was reduced to 0.02 ft/s and the elastomer was successfully discharged from the column. It can be seen that the elastomer did not agglomerate because the drag force of the gas balanced the weight of elastomeric material, thus minimizing the consolidation force.

What is claimed is:

1. A bulk handling method for maintaining granular material in a free-flowing state comprising
(i) loading the granular material into a vessel equipped with a gas distributor at or near the bottom of said vessel and a discharge means in the bottom of said vessel;
(ii) injecting a gas that is inert to said granular material upwardly through the gas distributor and through the granular material at a gas velocity that is equal to or slightly below the minimum fluidization velocity of said granular material in the vessel.

2. The method of claim 1 wherein the gas velocity ranges from 0.05 ft/s to 0.35 ft/s.

3. The method of claim 2 wherein the gas is selected from the group consisting of air, nitrogen, argon, a gaseous alkane, cycle gas, and mixtures thereof.

4. The method of claim 3 wherein the gas is heated to a temperature ranging from about ambient to 90° C.

5. The method of claim 1 wherein the gas distributor is a conical-hopper distributor or a plane flow hopper distributor.

6. The method of claim 1 wherein the granular material is a granular polymer.

7. The method of claim 6 wherein the granular polymer is selected from the group consisting of ethylene-propylene rubbers, ethylene-propylene-diene rubbers, polybutadiene rubbers, ethylene-butene and ethylene-butene-diene rubbers, high ethylene content propylene-ethylene block copolymers, poly(1-butene) (when produced under certain reaction conditions), very low density (low modulus) polyethylenes, and polyisoprene rubbers.

8. The method of claim 6 wherein said granular polymer contains an inert particulate material in an amount ranging from about 0.3 to about 80% by weight, based on the weight of the polymer produced.

9. The method of claim 6 wherein discharge of the granular polymer from the vessel is accomplished by lowering the gas velocity to an aeration velocity ranging from about 0.01 ft/s to 0.03 ft/s.
